(19) United States
(12) Patent Application Publication
(10) Pub. No.: US 2005/0289244 A1
(43) Pub. Date: Dec. 29, 2005

(54) Method for service chaining in a communication network

(76) Inventors: Himansu Sahu, Sunnyvale, CA (US); Pritam De, Milipitas, CA (US); Shashank Merchant, Santa Clara, CA (US); Gopi Krishna, Sunnyvale, CA (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/876,775

(22) Filed: Jun. 28, 2004

(51) Int. Cl. G06F 15/16; G06F 15/173

(52) U.S. Cl. 709/249; 709/225

(57) ABSTRACT

The invention relates to a method, system, network node and computer program for processing packet data in a communication network, which comprises at least a first network node. In the method a first packet is received at the first network node. In the first network node is assigned for the first packet a chain comprising at least two logical service entities based on at least one service determination rule. A data unit comprising at least part of the first packet is formed. The data unit is processed in at least one logical service entity in the chain and a second packet is transmitted from the first network node comprising data sent by at least one logical service entity in the chain. The benefits of the invention relate to improved flexibility in introducing new value-added service for packet data and improved performance in the first network node.

### BACKGROUND OF THE INVENTION

1. Field of the Invention

The invention relates to the providing of value-added services for packet data in communication networks. Particularly, the invention relates to the forwarding of packets through a chain of multiple logical service entities in at least one communication network.

2. Description of the Related Art

In the early days of the Internet packet processing was far simpler from network operator point of view. It was sufficient to plainly route packets from a source Internet Protocol (IP) address to a destination IP address. Since then the processing of packets has become much more complicated from network operator point of view. Firstly, with the exhaustion of IP addresses specific measures must be taken to be able to cope with insufficient number of inefficiently allocated IP addresses. Therefore, overlapping IP addresses are commonly used in different sub-networks. When packets originating from non-unique IP addresses are routed outside of a given sub-network to a backbone network, the source IP addresses must be translated to global IP addresses. This is done in a node called Network Address Translator (NAT). The NAT allocates global IP addresses from an address pool. Typically, a global IP address is allocated for the duration of a Transmission Control Protocol (TCP) connection.

Secondly, due to security concerns it must be possible to transmit information securely over insecure public IP networks between a first secure sub-network and a second secure sub-network. One option would be to use end-to-end encryption, but that complicates design in end-user clients and servers. Therefore, for example, IP Security (IPSEC) architecture has been developed. It is defined in association with the Internet Engineering Task Force (IETF) document IP version 6 Request For Comments (RFC) 2460. In IPSEC there are security gateways, via which packets are forwarded to an insecure sub-network. In the insecure network packets are sent through a security association, which forms an integrity-protected and encrypted tunnel for packets. At the other end of the tunnel there is either the destination host or another security gateway, which processes the packets received through the security association. If there is a security gateway at the other end of the tunnel, the packets are further forwarded by it towards the eventual destination host.

Thirdly, nowadays Internet service providers are required to provide value-added services in their networks in order to attract private and corporate subscribers to their network. Many such services require the introduction of intermediate nodes via which packets must be routed before routing them towards the eventual destination IP address. The intermediate nodes perform a variety of tasks, which may be associated with different protocol layers. Such intermediate nodes are also called proxies.

In the case of Differentiated Services (DiffServ) it is sufficient to process packets at IP layer to perform packet metering, marking, shaping and dropping. Differentiated Services are more closely defined in, for example, the IETF RFC 2475. In the case of Transmission Control Protocol (TCP) connection routing, packets must be processed at TCP layer. The purpose of TCP connection routing is, for example, to allocate servers from a server resource pool for TCP connection requests. Typically, such TCP connection requests are associated with Hypertext Transfer Protocol (HTTP) content requests. The HTTP is defined in the IETF RFC 2616. In the context of mobile networks TCP proxies are also used to enhance performance over a slow and unreliable link layer connections. In the case of an application layer proxy, multiple packets constituting an application layer message must be intercepted in an intermediate node. An application layer proxy comprises also the lower layers, that is, the IP layer and the TCP or UDP layer. Application layer proxies are used in a variety of services, which may be specific to the application protocol. Examples of application protocols, in which, proxies are used are Hypertext Transfer Protocol (HTTP, IETF RFC 2616), Session Initiation Protocol (SIP, IETF RFC 2543) and Simple Mail Transfer Protocol (SMTP, IETF RFC 2821). Application layer proxies are also used as application level gateways, which perform protocol adaptation between different application layer protocols.

In the case of HTTP examples of services applied are rerouting, barring, accounting and charging services. In rerouting services an HTTP GET operation specifying a given URL is redirected to a different URL so that the URL is rewritten. The actual domain name part in the URL may already have been translated into an IP address at the source node, so a new destination IP address must be written to the HTTP GET operation. In barring services the proxy intercepts and bars HTTP GET operations targeted to given URLs. In accounting and charging services the volume of HTTP traffic to and from a given server address may be counted, for example. The volume of traffic may be measured in terms of data volume, that is, the number of bytes, or number of requests and responses. In accounting and charging applications it is also necessary to match HTTP requests (for example, GET operation) with HTTP responses (for example, 200 OK response). The purpose is, for example, to avoid charging for requests for which no response is received. Therefore, the HTTP proxy must also maintain the state of the HTTP messaging.

In some cases proxy servers such as mentioned above are implemented as separate actual network elements. However, the providing of a whole gamut of services with separate network elements for each type of service becomes eventually difficult and expensive. Therefore, in some cases several proxy server functionalities may be implemented in a single physical network element as logical processing entities. A network element that implements several services may need to have a wide variety of processing entities. By a processing entity is meant herein an intermediate functionality configured between a packet source and a packet destination, which participates in the providing of a given service for the packets or higher layer protocol data units transmitted therein between the source and the destination. In more elaborated cases the processing entities implemented by a given network element may belong to different networks, which may be administered by different administrative authorities. The networks may have different IP address spaces. In order to route packets between different networks, the network element must comprise at least one processing entity to perform network address translation for packets passed between the networks. There may also be other processing entities that need to be traversed by packets for which the network address translation is performed. Further, some of the processing entities may be located outside of the original network element in a remote network element, for example, in cases where the processing involved requires special hardware or it is otherwise meaningful to distribute the functionality. In this case a packet is first transferred from the original network element to the remote network element in order to render it to the processing associated with the remote processing entity. Thereupon, it is transferred back to the original network element. A remote network element comprising a remote processing entity may belong to a different administrative domain.

Usually, when a packet arrives to a network element providing multiple processing entities pertaining to one or many services, the network element must decide which processing entities should be applied for the packet, that is, which processing entities the packet should traverse. For each processing entity a decision must be made whether the processing entity should handle the packet, that is, whether the packet should be passed to the processing entity. The packet needs to go through several decision points to determine which processing entities need to process the packet. The processing entities needed depend on the service that needs to be rendered to the packet. During the traversal of the packet through multiple processing entities, the decision point between two processing entities may become very complex and time consuming. Furthermore, the same decision may need to be made repetitively to determine whether a packet needs to be passed to a given processing entity or not.

Reference is now made to FIG. 1, which illustrates the aforementioned process of determining which particular processing entities need to handle a given packet received at a network element. In FIG. 1 there is a network node 100, which provides local and remote processing entities by means of which at least one service may be rendered to the packet. A processing entity is hereinafter referred to as a Logical Service Entity (LSE). Network node 100 is, for example, an IP router within an IP network or a Global Packet Radio Service (GPRS) support node. Network node 100 comprises an incoming protocol stack 111 for receiving IP packets and an outgoing protocol stack 121 for sending IP packets. Incoming and outgoing protocol stacks 111 and 121 comprise physical layer entities 110 and 120, link layer entities 112 and 122, and IP layer entities 114 and 124, respectively. The physical layer entities provide, for example, optical fiber connectivity. The link layer entities provide, for example, Synchronous Digital Hierarchy (SDH), Synchronous Optical Network (SONET), Asynchronous Transfer Mode (ATM) or Frame Relay connectivity. The IP layer entities handle packets in accordance with, for example, IPv4 or IPv6. Network node 100 comprises logical service entities 140, 142 and 146. Network node 100 provides also a relay entity 144, which is used to relay packets to and from a remote service entity 160 operating in remote node 102. A remote service entity is in other words an out-of-the-box logical service entity. Network node 100 comprises also decision points 130-136. Decision points 130, 132 and 136 have associated with them logical services entities 140, 142 and 146. Decision point 134 has associated with it logical service entity 160, which is accessed via relay entities 144 and 162. A packet passed to remote logical service entity 160 is illustrated with arrow 170 and a packet returned or sent by remote logical service entity 160 is illustrated with arrow 172.

A first IP packet received by network node 100 is represented using an arrow 116. The first IP packet is processed by incoming protocol stack 111 and eventually handled by IP layer entity 114. IP layer entity 114 passes the first IP packet to decision point 130. Decision point 130 determines based on, for example, IP layer header information, higher protocol layer header information within payload or other payload information in the first IP packet whether the first IP packet must be subjected to processing performed by logical service entity 140. If processing performed by logical service entity 140 is required for first IP packet, then decision point passes the first IP packet to logical service entity 140 as illustrated with arrow 185. Otherwise, decision point 130 passes the first IP packet to a next decision point 132 as illustrated with arrow 181. When logical service entity 140 has performed processing on first IP packet, logical service entity 140 passes it to decision point 132 as illustrated with arrow 186. In the same manner each decision point 130-136 of FIG. 1 in turn inspects the first IP packet and makes the decision whether the first IP packet is to be passed to the logical service entity associated with the decision point. When each logical service entity has processed the first IP packet, it is passed by them to the next decision point. If the logical service entity is remote, it is passed via relay entities to the next decision point.

As a result of processing performed by logical service entity 142 the first IP packet may have to be repeatedly subjected to inspection at decision point 130. This is illustrated with arrow 190, which represents the loop back to decision point 130. The first IP packet may have been modified by logical service entity 142 in a way, which makes it necessary to inspect whether logical service entity 140 should process it repeatedly. When the last logical service entity 146 has processed the first IP packet, it is forwarded to outgoing protocol stack entity 121. Thereafter, the first IP packet is subjected to routing decisions for determining the next network element to which it must be sent. Subsequent IP packets received at network node 100 in incoming protocol stack entity 111 are subjected to similar processing through the chain of decision points and logical service entities.

The disadvantage of a solution such as illustrated in FIG. 1 is that a decision point between two adjacent logical service entities may become extremely complex and expensive to implement and maintain. Furthermore, same decisions may need to be made repetitively to determine if a packet needs to be passed to a logical service entity or not. For example, if same higher layer protocol headers must be detected and parsed in a similar manner in several decision points, the performance of network node 100 is reduced significantly. Let us assume, for example, that logical service entities 140 and 160 are configured to act as HTTP proxies for any packets carrying HTTP GET operations requesting a URL, which belongs to given set of URL. In this case decision points 130 and 134 must both comprise same functionality, which scans packets containing TCP and HTTP headers, parses HTTP headers to determine the URL and then checks whether the requested URL belongs to the given set of URLs.

Additionally, the configuration of new services to a network node such as network node 100 is complicated. The software in network node 100 must be updated to reflect the new logical service entities and the associated decision points that need to be added to the existing chain of logical service entities. The aim of the invention disclosed herein is to alleviate the problems discussed hereinbefore and to introduce flexibility in the creation, modification and execution of processing entity, that is, logical service entity chains. The processing performance of value-added services in network nodes is improved by avoiding double processing associated with service determination, where the required logical service entities for a value-added service are determined.

### SUMMARY OF THE INVENTION

The invention relates to a method of processing packet data in a communication network, comprising at least a first network node. In the method a first packet is received at the first network node. In the first network node a chain comprising at least two logical service entities is assigned for the first packet based on at least one service determination rule. A data unit comprising at least part of the first packet is formed and the data unit is processed in at least one logical service entity in the chain.

The invention relates also to a system comprising at least a first network node. The system further comprises: a receiving entity in the first network node configured to receive a first packet; an assigning entity in the first network node configured to assign a chain comprising at least a first logical service entity and a second logical service entity for the first packet; a service chain control entity configured to form a data unit comprising at least part of the first packet; the first logical service entity configured to process the data unit and to form a second data unit; and the second logical service entity configured to process the second data unit.

The invention relates also to a network node comprising: a receiving entity in the first network node configured to receive a first packet; an assigning entity in the first network node configured to assign a chain comprising at least a first logical service entity and a second logical service entity for the first packet; a service chain control entity configured to form a data unit comprising at least part of the first packet, to pass the data unit to the first logical service entity and to pass a second data unit received from the first logical service entity to the second logical service entity.

The invention relates also to a computer program comprising code adapted to perform the following steps when executed on a data-processing system: receiving a first packet at the first network node; assigning in the first network node a chain comprising at least two logical service entities for the first packet based on at least one service determination rule; forming a data unit comprising at least part of the first packet; and processing the data unit in at least one logical service entity in the chain.

In one embodiment of the invention a second packet is transmitted from the first network node comprising data sent by at least one logical service entity in the chain. The second packet is transmitted as the data unit has traversed the at least one logical service entity in the chain. In this embodiment, there are transmitting means in the first network node for transmitting a second packet from the first network node comprising data sent by at least one of the first logical service entity and the second logical service entity.

In one embodiment of the invention, the data unit is processed in a first logical service entity and a second logical service entity in the chain. The first logical service entity passes the data unit to the second logical service entity. The data unit may be modified by the first logical service entity before it is passed to the second logical service entity. A second packet is formed using a data unit, which is received from the second logical service entity or generally the last logical service entity in the chain, and is transmitted from the first network node. At least one of the logical service entities may buffer data units that it has received, before passing a data unit to the next logical service entity in the chain or to the service chain control entity. In one embodiment of the invention, the logical service entities are executed in the first network node.

In one embodiment of the invention, the processing step in at least one logical service entity comprises the parsing and the handling of higher protocol layer information obtained from the data unit, which was formed using the first packet. For example, the higher protocol layer information may comprise TCP or UDP headers, application protocol message headers like HTTP or SIP headers.

In one embodiment of the invention, processing step in at least one logical service entity comprises the determining of required actions based on a service tag received from the service chain control means. In one embodiment of the invention service tag are also used to identify logical service entities.

In one embodiment of the invention, the processing step in at least one logical service entity comprises the checking of at least one trigger condition for the data unit and the execution of at least one action on the data unit.

In one embodiment of the invention, a service is selected for at least one end-user. The service is selected by an end-user personally or by a system administrator performing service provisioning in the network. Information on the selected service is provided to a service policy manager entity, which is, for example, a service management node in the communication network. The selection of the service is performed via a separate user interface, which is based on, for example, a WWW-site provided by the communication network operator. In the service management node at least two logical service entities based on the service are determined. A chain comprising the at least two logical service entities is determined based on the service. At least one trigger condition and at least one action are determined based on the service. The service determination rule is determined based on the service and user information associated with the at least one end-user. The service determination rule, the chain, the at least one trigger condition and the at least one action are provided to the first network node from the service management node.

In one embodiment of the invention, the logical service entities have unique identifiers. In one embodiment of the invention, the chain is assigned a unique chain identifier, for example, a Master Service Chain Template Identifier (MSCTID) and the chain identifier is added into the service determination rule. The chain identifier may be used in the network node to obtain information associated with the chain, for example, the at least two logical service entities comprised in the chain. In one embodiment of the invention, the information associated with the chain comprises the logical service entity unique identifiers.

In one embodiment of the invention, the user information is user data provided to the first network node from a user database. The user database may be, for example, a Home Location Register (HLR) in a General Packet Radio System (GPRS) network.

In one embodiment of the invention, the user information is a condition for comparing at least part of the source address in the first packet to a value associated with the at least one end-user.

In one embodiment of the invention, the logical service entity is located in a second network node, which is accessed by the service chain control entity from the first network node.

In one embodiment of the invention, the receiving entity is a protocol stack. In one embodiment of the invention, the assigning entity is a service chain determination entity. In one embodiment of the invention, the service chain control entity comprises also the assigning entity.

In one embodiment of the invention, the logical service entities, the service chain determination entity and the service chain control entities are comprised in a common software process or separate software processes executed in the first network node. The entities may also be implemented as threads executed in one or many software processes. In one embodiment of the invention, at least one of the receiving, assigning, service chain determination and service chain control entities may be implemented as at least one separate computer unit within the first network node.

In one embodiment of the invention, the communication network is a mobile communication network, for example a General Packet Radio System (GPRS) Network. The first network node may be, for example, a Serving GPRS Support Node (SGSN) or a Gateway GPRS Support Node (GGSN), which obtains information on the service determination rule from Packet Data Protocol (PDP) context information associated with a mobile subscriber. The obtained service determination rule is applied for packets sent or received by the mobile subscriber's terminal.

In one embodiment of the invention, the communication network is an IP network and the first network node is an IP router. The IP router may be, for example, a backbone network router or an access router connected to subscriber lines. In one embodiment of the invention, the communication network may be any packet switched communication network.

In one embodiment of the invention, the computer program is stored on a computer readable medium. The computer readable medium may be a removable memory card, read-only memory circuit, magnetic disk, optical disk or magnetic tape. The computer readable medium is accessed by, for example, the first network element.

In one embodiment of the invention, the service determination rule is checked in a separate service chain determination entity. In another embodiment of the invention, the service chain determination entity is comprised in the service chain control entity.

The benefits of the invention are related to the improved flexibility in introducing new services in a communication network. The configuration of network nodes becomes easier. The processing performance of value-added services in network nodes is improved by avoiding double processing associated with service determination.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 (PRIOR ART) is a block diagram illustrating a prior art network node comprising several logical service entities;

FIG. 2 is a block diagram illustrating a system comprising a network node, which is configured to provide several logical service entities, according to the invention;

FIG. 3 is a flow chart depicting one embodiment of a method for setting up a logical service entity chain in a system of FIG. 2 or FIG. 6, according to the invention;

FIG. 4 is a flow chart depicting one embodiment of a method for service provisioning in a system of FIG. 6, according to the invention;

FIG. 5 is a flow chart depicting one embodiment of a method for packet handling in a system of FIG. 6, according to the invention;

FIG. 6 is a block diagram illustrating a system comprising a network node, which is configured to provide several logical service entities, which process packets based on predefined rules, according to the invention;

FIG. 7A is a block diagram illustrating a data structure for provisioning a logical service entity chain in a system of FIG. 2, according to the invention;

FIG. 7B is a block diagram illustrating a data structure for a packet traversing a logical service entity chain in a system of FIG. 2, according to the invention;

FIG. 8 is a block diagram illustrating an embodiment of the invention where a system of FIG. 2 is provided by General Packet Radio Service (GPRS) Network, according to the invention; and

FIG. 9 is a block diagram illustrating a logical service entity in one embodiment of the invention, according to the invention.

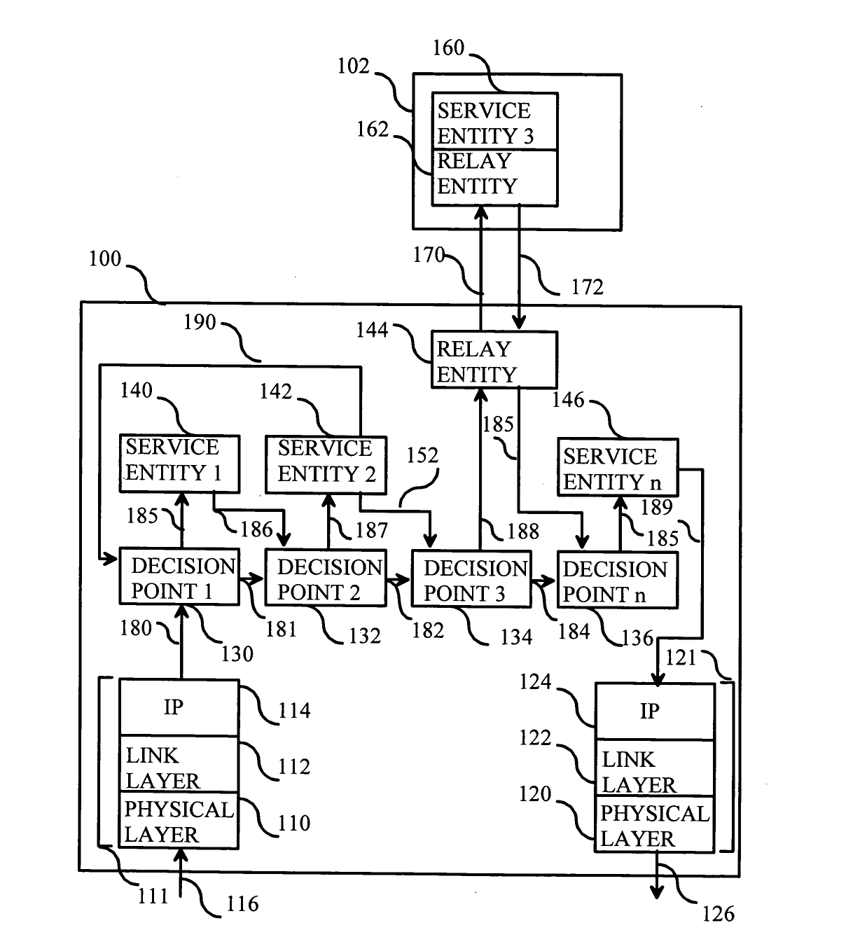

### DETAILED DESCRIPTION OF THE EMBODIMENTS

Reference will now be made in detail to the embodiments of the present invention, examples of which are illustrated in the accompanying drawings.

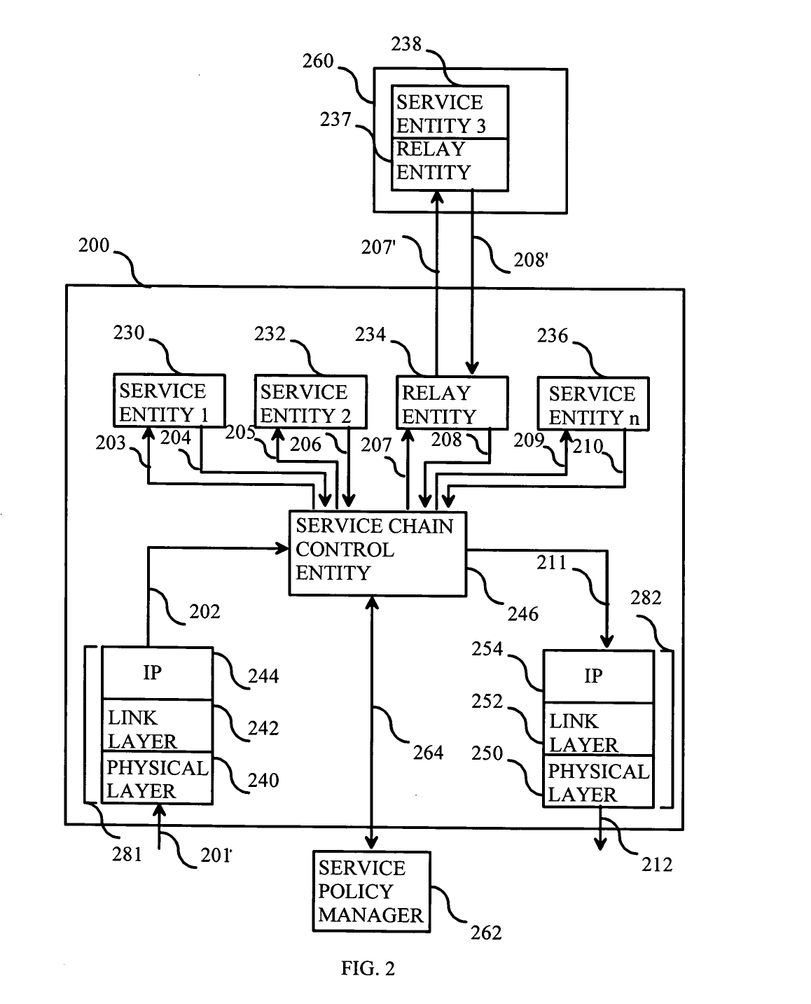

FIG. 2 is a block diagram illustrating a system comprising a network node, which is configured to provide several logical service entities, according to the invention. In FIG. 2 there is a network node 200, which comprises an incoming protocol stack 201 for receiving IP packets and an outgoing protocol stack 212 for sending IP packets. Network node 200 may be an IP router, an access router, an edge router or a general-purpose server computer for processing packet data. Incoming and outgoing protocol stacks 201 and 212 comprise physical layer entities 240 and 250, link layer entities 242 and 252, and IP layer entities 244 and 254, respectively. The physical layer entities provide, for example, optical fiber connectivity. The link layer entities provide, for example, Synchronous Digital Hierarchy (SDH), Synchronous Optical Network (SONET), Asynchronous Transfer Mode (ATM) or Frame Relay connectivity. The IP layer entities handle packets in accordance with, for example, IPv4 or IPv6. Either IP layer entity 244 or 254 comprises means for routing IP packets, that is, for determining the next hop along the route to the destination of the IP packet. Network node 200 comprises logical service entities 230, 232 and 236. Network node 200 provides also a relay entity 234, which is used to relay packets to and from a remote service entity 238 operating in remote network node 260. A remote service entity is in other words an out-of-the-box logical service entity. In remote network node 260 there is also a relay entity 237. Packets to and from logical service entity 238 are sent via relay entities 234 and 237. The number of logical service entities in FIG. 2 is only for illustrative purposes, there may be any number of logical service entities in a network node according to the invention. Similarly, any number of the logical service entities may be remote. In one embodiment of the invention, there are no remote logical service entities—all logical service entities are local to the network node 200.

A packet received to network node 200 is first received in physical layer entity 240. This happens so that at least one frame carrying data from the packet is passed to link layer entity 242. The receiving of a packet is illustrated with arrow 201. From link layer Service Data Units (SDU) received from the link layer entity 242 IP layer entity 244 gathers the complete IP packet. Thereupon, IP layer entity 244 performs a routing decision, which determines that the IP packet must be passed to a service chain control entity 246. There may be other routing decisions performed by other routing entities within network node 200. Service chain control entity 246 determines, which logical service entities a given IP packet must traverse. The determination of the logical service entities to be traversed is performed, for example, so that service chain control entity 246 analyses the IP packet headers. Also higher protocol layer headers carried in IP packet payload may also be parsed by service chain control entity 246. Service chain control entity 246 may similarly scan the packet for other identifiable information in the packet payload part.

In FIG. 2 an IP packet is first passed from service chain control entity 246 to logical service entity 230 as illustrated with an arrow 203. After the handling of the packet in logical service entity 230 it is returned to service chain control entity 246 as illustrated with an arrow 204. Thereupon, the IP packet is handled similarly pertaining to the other logical service entities 232, 238 and 236. To logical service entity 238, the IP packet is passed via relay entities 234 and 237. Relay entities 234 and 237 may wrap the IP packet to the payload in another IP packet in order to tunnel the IP packet between them. Similarly, the interface between service chain control entity 246 and logical service entity 238 may be based on a remote method call interface such as Common Object Request Broker Architecture (CORBA), Microsoft COM™ or Simple Object Adapter Protocol (SOAP). The remote method calls may further be carried over a reliable protocol for carrying method calls such as HTTPR specified by IBM or Blocks Extensible Exchange Protocol (BEEP) specified in the IETF RFC 3080. When the IP packet has traversed all required logical service entities, it is passed to IP layer protocol entity 254 in outgoing protocol stack entity 281. Thereupon, IP layer protocol entity 254 may perform further routing to the IP packet. In one embodiment of the invention, the routing decision is for the IP packet is performed already at ingress to the network node 200, for example, in IP layer entity 244 or a separate entity associated therewith.

In one embodiment of the invention a service rendered to IP packets may be defined in the following formal way. A service consists of one or more policies. Each policy comprises two parts: a trigger condition and at least one action. The trigger condition is a trigger rule, which defines the IP packets that must be subjected to the policy. In other words, if a user packet matches the trigger condition, then the at least one action defined in the policy are taken on the IP packet. With this definition, when an operator wants to deploy a service, it expresses the service as a set of policies. For example, an E-mail service may be specified in the following way. The trigger condition for a given IP packet is: that the packet destination IP address is equal to the IP address of a given E-mail server, that the TCP port number within the TCP header carried in the IP packet payload is equal to SMTP port number, which is usually 25. The action is that the number of bytes in the IP packet must be added to the total count of bytes received to and from the E-mail server. In a similar manner a processing entity, that is, a logical service entity forming a part of a larger service may be defined as a pair comprising a trigger rule and at least one action. The trigger rule specifies the packets that must be subjected to the at least one action. For a logical service entity the trigger rule may also be void i.e. empty, which means that there are no trigger criteria required and all packets passed to the logical service entity from a service chain control entity must be subjected to the at least one action. In this case a different nonempty trigger rule may be applied as a service chain determination rule at the service chain control entity or any other entity that performs the service chain determination.

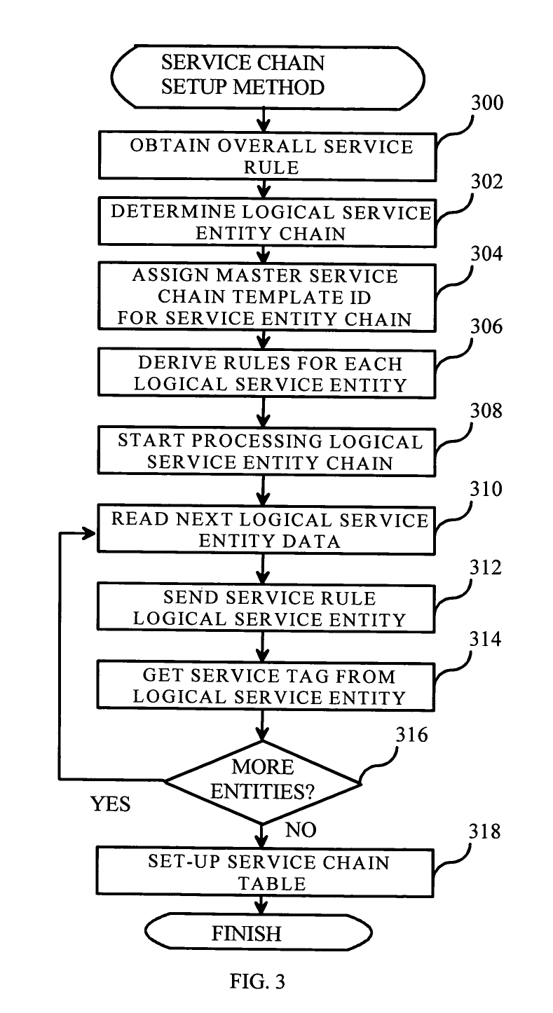

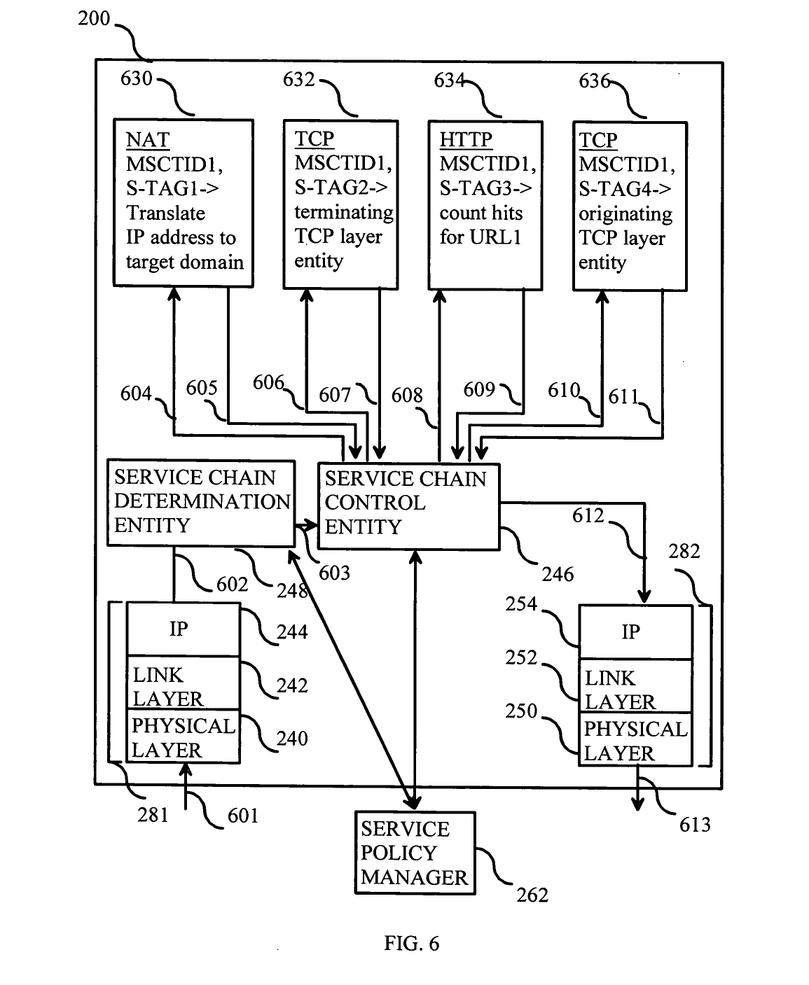

FIG. 3 is a flow chart depicting one embodiment of a method for setting up a logical service entity chain in a system of FIG. 2 and FIG. 6, according to the invention. At step 300 an overall service rule or specification is obtained by a service policy manager entity 262. The service policy manager entity may be provided in network node 200 or it may be a separate network node used for managing network node 200. The service specification defines the service functionality in a higher level. The service specification defines the service, for example, in terms of a single policy, which is independent of actual protocol layers and parameters specific to them. The policy may be decomposed into a set of protocol layer specific policies that must be implemented using a particular chain of logical service entities. For example, let us assume that an operator wants to deploy a first service, which is hit-based URL charging service for WWW related traffic in its network. The first service specification for the first service states that content requests received and fulfilled by a content server must be counted in the operators network. The first service specification also states that content servers belong to a different routing domain than the operator's network.

At step 302 service policy manager entity 262 determines the logical service entities required for achieving the first service according to the first service specification. In one embodiment of the invention, each such logical service entity is identified using an appropriate Logical Service Entity Identifier (LSE-ID). Similarly, the order of the logical service entities required is determined. For the first service, it is determined that the logical service entities are a network address translation entity 630, a terminating TCP layer entity 632, an HTTP proxy entity 634 and an originating TCP layer entity 636 as illustrated in FIG. 6. In this case all logical service entities are performed in network node 200. The requirement of logical service entity 630 for network address translation is determined from the fact that the content servers are located in a different routing domain. The requirement for HTTP proxy entity 634 is determined from the need to match content request operations and their responses in order to count the requests among the total number of requests. Additionally, it is determined that for the time being only HTTP requests are counted, not SIP or Real-Time Streaming Protocol (RTSP) requests for the time being. RTSP is defined in the IETF RFC 2326. However, also these protocols may be handled using the invention disclosed herein. From the fact that there is an HTTP proxy entity among the logical service entities, it is determined that it must have a terminating TCP layer entity on its incoming side and an origination TCP layer entity on its outgoing side. Therefore, logical service entities 632 and 636 are also required in the logical service entity chain being formed.

At step 304 a Master Service Chain Template ID (MSCTID) is assigned for the service entity chain that is being formed. The MSCTID will be used in identifying and referring to the logical service entity chain.

At step 306 service policy manager entity 262 decomposes the service specification into a set of logical service entity specific policies that are implemented in the logical service entities determined at step 302. For logical service entity 630 a trigger for packets originating from a specified set of IP addresses is defined. The action will be to perform network address translation for source IP address in the IP packets. For logical service entity 632 an action is defined, which is to perform terminating TCP layer protocol entity. This means that a TCP connection carried out using packets received to logical service entity 632 is terminated at it. For logical service entity 634 a trigger is defined to handle specified HTTP protocol messages, for example, HTTP GET and 200 OK. The action will be to match HTTP GET operations and their 200 OK responses. In case there is a match, a counter for the total number of requests is incremented by one. For logical service entity 636 an action is defined, which is to act as an originating TCP layer protocol entity. This means that a TCP connection is originated at logical service entity 636 towards the destination of the HTTP request. Typically, the TCP connection is terminated at a content server to which the URL of the HTTP request points.

At step 308 service policy manager entity 262 sends the logical service entity specific policies comprising the actions and triggers to service chain control entity 246. Similarly, it sends information on the required logical service entities and their mutual order of traversal. The sending of these pieces of information is achieved, for example, so that service policy manager entity 262 opens a managing session to network node 200 and issues commands to it, which provide information on the triggers and actions, and request the service chain control entity 246 to start setting up a logical service entity chain as specified. In one embodiment of the invention, a bulk download of a service configuration information file is used to carry information from service policy manager entity 262 to service chain control entity 246. The file may be, for example, in Extensible Markup Language (XML) format. After having received the necessary information, the service chain control entity 246 starts processing the logical service entity chain information provided to it.

At step 310 service chain control entity 246 reads information on a logical service entity, which has not yet been processed from the information provided from service policy manager entity 262. At step 312 service chain control entity 246 sends the policy information comprising the trigger condition and action information to the logical service entity. The logical service entity invoked at this time may be only a managing entity, which does not comprise the full functionality of the logical service entity that will eventually process the packets and implement the policy. At step 314 service chain control entity 246 receives a service tag (S-TAG) from the logical service entity in an acknowledgement. The service tag will subsequently identify the received policy in the logical service entity. At step 316 service chain control entity 246 checks if there are more logical service entities to be configured, which have not yet been passed their policy information. If there are more logical service entities, processing continues at step 310 for the next logical service entity in the chain.

At step 318 service chain control entity 246 sets up a service chain table, which specifies the route of logical service entities and the service tags pertaining to a given MSCTID.

For example, in FIG. 6 logical service entity 630 is configured first. Thereafter, logical service entities 632, 634 and 636 are configured.

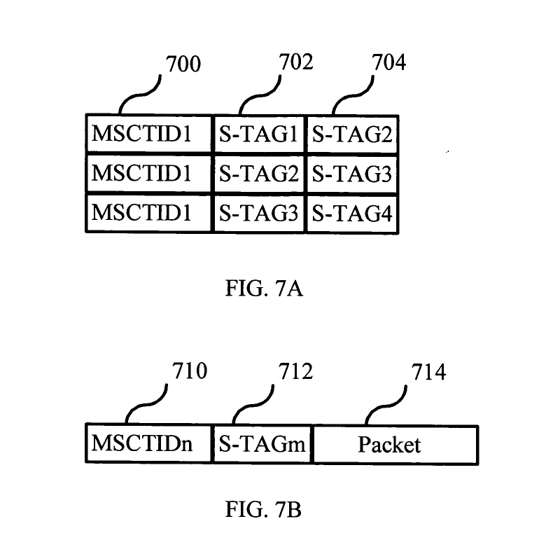

FIG. 7A illustrates the service chain table data structure in one embodiment of the invention. In the table, there is a column 700 that comprises an MSCTID, a column 702 that comprises a first service tag, and a column 704 that comprises a second service tag. The service tags identify an address or an identifier of the logical service entity, for example, an LSE-ID, for the use of the service chain control entity 246 and within the logical service entity they identify the policy, which is to be executed by the logical service entity when an IP packet or a request message carrying information from the IP packet is received by it. In one embodiment of the invention, a service tag comprises two parts: a part identifying the logical service entity and a second part identifying the policy, which is to be executed by the logical service entity. A first service tag specifies a first logical service entity, which should process a packet first. The second service tag identifies a second logical service entity, which must receive the packet immediately after the first logical service entity. In one embodiment of the invention, the service chain table comprises an index, which identifies the order of logical service entities that should receive packets pertaining to the logical service entity chain identified with MSCTID.

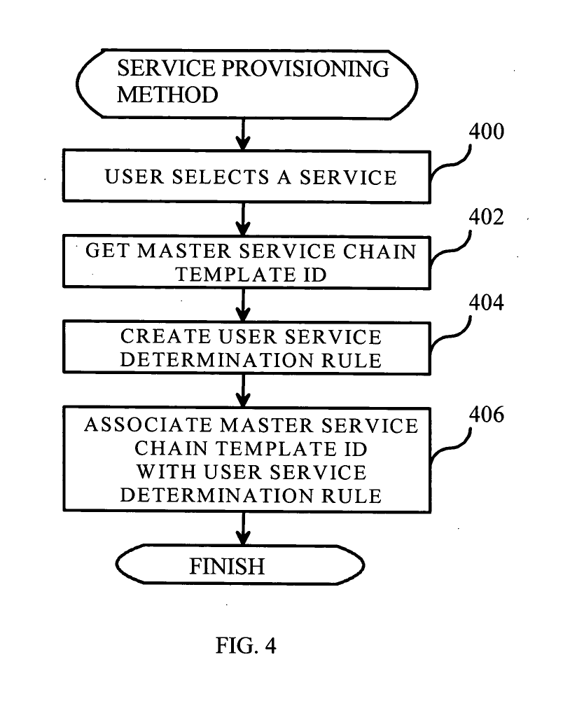

FIG. 4 is a flow chart depicting one embodiment of a method for service provisioning in a system of FIG. 6, according to the invention. First, a logical service entity chain is established according to the method illustrated in FIG. 3. The logical service entity chain established is referred to with an MSCTID.

At step 400 a user selects a service. The provisioning of the service for the user may be performed at the request of an individual end-user or at the request of a system administrator performing network management. A system administrator may deploy a service for a multitude of users, for example, so that the system administrator defines certain criteria, which filter the IP packets that must be subjected to the processing associated with the service. This occurs especially if network node 200 is a backbone network router, to which no direct end-user related information is available. In one embodiment of the invention network node 200 is able to differentiate packets originating from individual end-users. In this embodiment, the information about the provisioned service may be added to the service data of the end-user. The end-user or the system administrator selects a given service to be activated. The service is, for example, the first service discussed in association with the description of FIG. 3. The information on the selected service is provided to service policy manager entity 262. In one embodiment of the invention, service policy manager entity 262 provides a management user interface for selecting a service and defining a service determination rule, which is used to filter the IP packets, for which the service is applied.

At step 402 the MSCTID for the selected service is determined by the service policy manager entity 262. At step 404 service policy manager 262 creates the service determination rule for a service chain determination entity 246. The service determination rule is used in the service chain determination entity 246 to determine the MSCTID for a logical service entity chain, which a given IP packet must traverse. The service determination rule is a special case of a policy, wherein the trigger determines the packets to be processed and the action is that the packet must traverse the logical service entity chain identified with the MSCTID. For example, the service determination rule comprises the checking of the IP packet header fields, fields in higher protocol layer headers and generally the payload of IP packet. Typically, the information in header field or in the payload is compared to a certain predefined values or data obtained from a database or a memory table in association with service chain determination entity 246. For example, it may be checked if the source or the destination IP addresses have a given prefix. It may also be checked if the packets received originate from an end-user or a subscriber line identified separately in the service determination rule.

At step 406 service chain determination entity 248 associated MSCTID with the service determination rule, for example, at the request of the service policy manager entity 262.

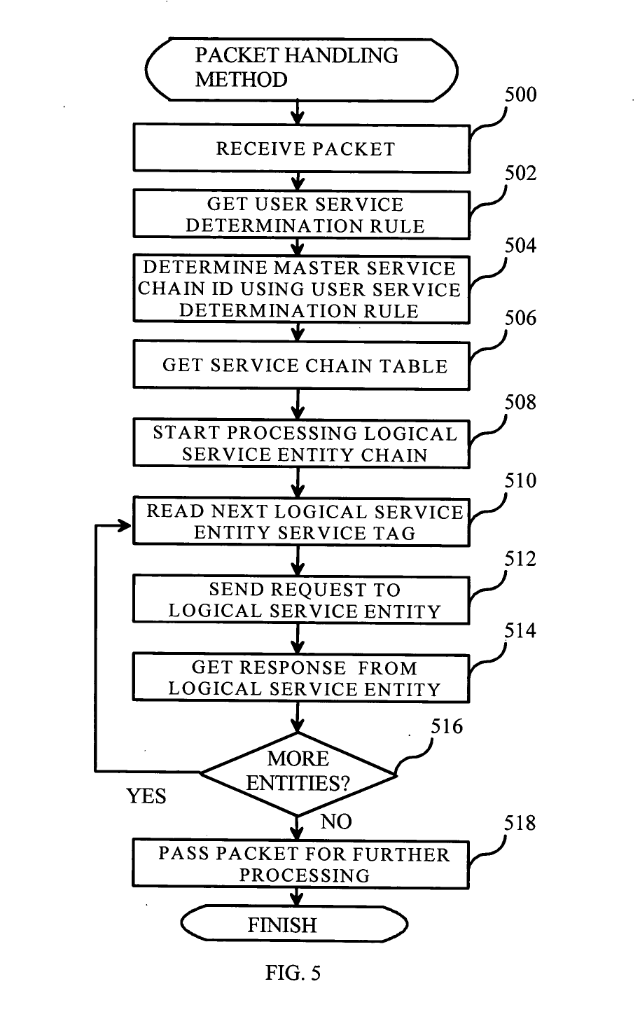

FIG. 5 is a flow chart depicting one embodiment of a method for packet handling in a system of FIG. 6, according to the invention. At step 500 a first IP packet is received by network node 200 as illustrated with arrow 601. The first IP packet is processed through incoming protocol stack entity 281. At the IP layer entity may be performed a routing decision for the first IP packet. For example, a preliminary destination comprising a set of next hop routers may be determined. The routing decision is based on IP routing principles. Irrespective of the routing decision first IP packet is passed to service chain determination entity 248 as illustrated with arrow 602.

At step 502 service chain determination entity 248 gets a service determination rule. In one embodiment of the invention, the service determination rule may be obtained by preliminary inspection of the first IP packet headers or its origin. For example, at least one service determination rule may be obtained from service data associated with the end-user from which the first IP packet is sent. Similarly, at least one service determination rule may be obtained based on a prefix of a source or a destination IP address.

At step 504 the at least one service determination rule is checked pertaining to the first IP packet. Based on the checking of the at least one service determination rule, service chain determination entity 248 obtains the MSCTID, which specifies the logical service entity chain applied for the first IP packet. At step 506 service chain determination entity passes the packet to service chain control entity 246 as illustrated with arrow 603. The service chain control entity 246 obtains the service chain table entries associated with the MSCTID. Based on the service chain table entries, the service tags, which specify the logical service entities and their chain are obtained to the service chain control entity 246.

At step 508 service chain control entity 246 start processing the logical service entity chain. At step 510 service chain control entity 246 gets the service tag, which specifies the next logical service entity to which the first IP packet must be passed. Service chain control entity 246 forms a message request, in other words, a data unit structured as illustrated in FIG. 7B in which the first IP packet data is passed to the next logical service entity. The request message comprises a field for MSCTID 710, a field for the service tag 712 and a field for the actual first IP packet 714. It should be noted that field 714 may also carry only a part of the first IP packet contents. For example, some header fields may be omitted when storing first IP packet information to field 714. In one embodiment of the invention, the field 714 and thus the request message carry an entire IP packet, for example, the first IP packet.

At step 512 service chain control entity 246 passes the message to the next logical service entity determined based on the service tag. In FIG. 6 the next logical service entity is one of the logical service entities 630-636. The logical service entity obtains the first IP packet and applies a service policy specified by the service tag for the packet. A logical service entity may have associated with it information pertaining to multiple service policies. The logical service entity determines if the trigger criteria for the policy are fulfilled and performs the actions associated with the policy. It should be noted that the trigger criteria may be void and thus there may be no trigger criteria to be checked, only at least one action to be executed by the logical service entity. The logical service entity passes the possibly modified first IP packet back to service chain control entity 246. In one embodiment of the invention the first IP packet may be completely dropped by the logical service entity and that a completely new IP packet is generated by the logical service entity, for example, to be returned back to the source IP address of the first IP packet. In one embodiment of the invention, an action executed in response to the policy may not be complete until a second IP packet is received from, for example, the destination of the first IP packet. This takes place, for example, when an application protocol request message is matched with a response message to it.

At step 514 service chain control entity 246 gets the first IP packet from the logical service entity, which processed the packet. At step 516 service chain control entity 246 determines if there are more logical service entities remaining in the chain. If there are more logical service entities remaining processing continues at step 510, where based on the obtained service chain table entries associated with MSCTID. Next service tag is determined by picking the entry, which has the previous service tag in the column 702. In other words, a previous service tag identifies the next service tag and using the service tag the next logical service entity is determined.

The traversal order of logical service entities 630-636 is illustrated in FIG. 6 using arrows 604-611. Finally, the first IP packet is passed to outgoing protocol stack entity 282. The IP layer protocol entity may perform further routing for the first IP packet. For example, an outgoing port unit may be determined. A second IP packet or any subsequent IP packet received at network node 200 is handled in a similar way. It should be noted that some of the logical service entities 630-636 may perform packet buffering in order to be able to extract complete higher protocol layer messages from a sequence of related packets.

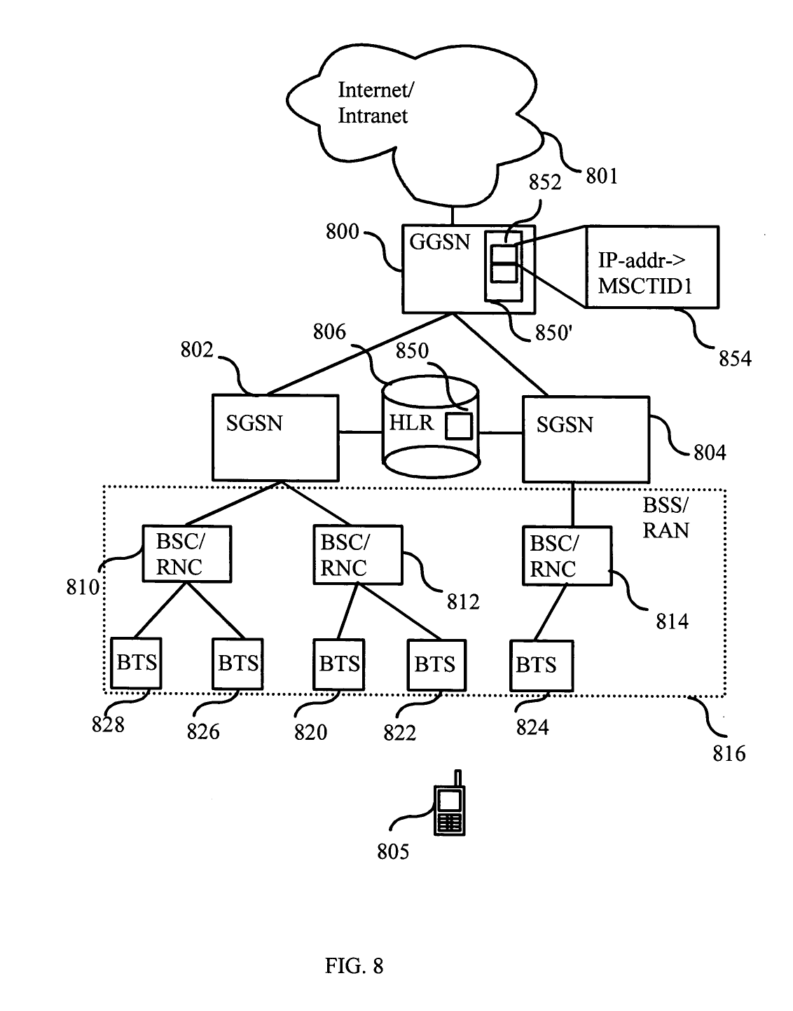

FIG. 8 illustrates an embodiment of the invention where a system of FIG. 2 or FIG. 6 is provided in a General Packet Radio Service (GPRS) Network, according to the invention. The GPRS network comprises a Gateway GPRS Support Node 800, Serving GPRS Support Nodes 802 and 804, Home Location Register 806, radio access network 816, radio network nodes 810-814 and Base Station Controllers (BTS) 824-828. The GPRS network also comprises at least one mobile node 805. The GPRS system is specified in the 3G Partnership Project (3GPP) specification 23.060. The GGSN 800 provides an access point to an IP network 801, which is an Intranet or the Internet. The HLR stores subscriber data associated with a mobile subscriber whose Subscriber Identification Module (SIM) card is plugged in mobile node 805. The mobile subscriber data is distributed to SGSNs during location updates performed by mobile node 805. Simultaneously, Packet Data Protocol Context (PDP) information 850′ in subscriber data 850 is updated from SGSN 802 or SGSN 804 to the GGSN 800, depending on the current SGSN. In one embodiment of the invention, the PDP context data 850′ comprises at least one service determination rule 854. Using the at least one service determination rule 854 a MSCTID is determined. The trigger criteria in the rule may comprise, for example, the checking of destination IP address. In one embodiment of the invention either SGSNs 802, 804 or GGSN 800 perform the logical service entity chaining functionality as illustrated in FIG. 2 or FIG. 6 relating to network node 200. Therefore, service chain determination entity 248 first obtains the PDP context data 850′ associated with a received IP packet. From the PDP context data 850′ is determined a set of service determination rules, which specify other relevant trigger criteria for determining the MSCTID.

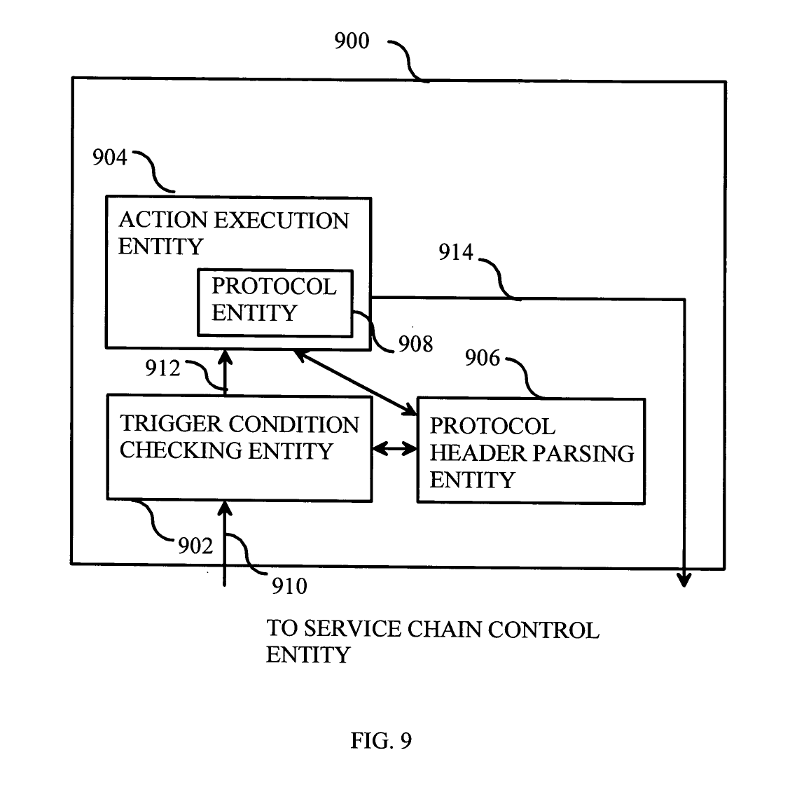

FIG. 9 is a block diagram illustrating a logical service entity such as logical service entities 630-636 in FIG. 6 in one embodiment of the invention. In FIG. 9 there is a logical service entity 900, which receives data units, that is, request messages from a service chain control entity as illustrated with arrow 910. Logical service entity 900 sends data units back to the service chain control entity as illustrated with arrow 914. Logical service entity 900 comprises a trigger condition checking entity 902, an action execution entity 904 and a protocol header parsing entity 906. Trigger condition checking entity 902 extracts a service tag received in a request message, obtains the policy associated with it and matches the trigger criteria in the policy with received IP packet information. If the trigger criteria match or there were no trigger criteria, the received IP packet information is passed to action execution entity 904. If there is a need to check higher layer protocol header information in association the checking of the trigger criteria or the execution of the actions, a protocol header parsing entity 906 is used.

Action execution entity 904 executes the at least one action prescribed with the policy identified by the service tag. One of the actions may be to execute a protocol entity in the logical service entity 900. Therefore, action execution entity 904 may also comprise a protocol entity 908 for a protocol entity implemented in the logical service entity. Examples of possible protocol entities include TCP, UDP, HTTP and SIP. In one embodiment of the invention, there may be several protocol entities comprising an entire protocol stack in the logical service entity. In one embodiment of the invention, the incoming and outgoing messages as indicated using arrows 910 and 914 are conveyed between logical service entity 900 and a service chain control entity via at least one relay entity. The relay entities may form an application protocol or a transport protocol between a first network node hosting at least the service chain control entity and a second network node hosting the logical service entity.

It is obvious to a person skilled in the art that with the advancement of technology, the basic idea of the invention may be implemented in various ways. The invention and its embodiments are thus not limited to the examples described above; instead they may vary within the scope of the claims.

1. A method of processing packet data in a communication network, comprising at least a first network node, the method comprising:
receiving a first packet at said first network node;
assigning in said first network node a chain comprising at least two logical service entities for said first packet based on at least one service determination rule;
forming a data unit comprising at least part of said first packet; and
processing said data unit in at least one logical service entity in said chain.

2. The method according to claim 1, wherein said processing step comprises parsing and handling of higher protocol layer information obtained from said data unit.

3. The method according to claim 1, wherein required actions in said processing step are determined based on a service tag.

4. The method according to claim 1, wherein said processing step comprises checking of at least one trigger condition for said data unit and the execution of at least one action on said data unit.

5. The method according to claim 4, the method further comprising:
selecting a service for at least one end-user;
determining at least two logical service entities based on said service;
forming said chain comprising said at least two logical service entities based on said service;
determining said at least one trigger condition and at least one action based on said service; and
determining said service determination rule based on said service and user information associated with said at least one end-user.

6. The method according to claim 5, wherein said user information is user data provided to said first network node from a user database.

7. The method according to claim 5, wherein said user information is a condition for comparing at least part of the source address in said first packet to a value associated with said at least one end-user.

8. The method according to claim 5, wherein said logical service entities have unique identifiers.

9. The method according to claim 5, the method further comprising:
assigning said chain a unique chain identifier; and
adding said chain identifier into said service determination rule.

10. The method according to claim 1, wherein said logical service entity is located in a second network node.

11. The method according to claim 1, wherein said communication network is a mobile communication network.

12. The method according to claim 10, wherein said communication network is a General Packet Radio System (GPRS) Network.

13. The method according to claim 1, wherein said communication network is an IP network and said first network node is an IP router.

14. A system comprising at least a first network node, the system further comprising:
a receiving entity in said first network node configured to receive a first packet;
an assigning entity in said first network node configured to assign a chain comprising at least a first logical service entity and a second logical service entity for said first packet;
a service chain control entity configured to form a data unit comprising at least part of said first packet;
said first logical service entity configured to process said data unit and to form a second data unit; and
said second logical service entity configured to process said second data unit.

15. The system according to claim 11, the system further comprising:
processing entities in said first and second logical service entities configured to parse and to handle higher protocol layer information obtained from said data unit.

16. The system according to claim 14, the system further comprising:
processing entities in said first and second logical service entities configured to determine required actions based on service tags received from said service chain control entity.

17. The system according to claim 14, wherein said first and second logical service entities comprise checking entities configured to check at least one trigger condition for said data unit and execution entities configured to execute at least one action on said data unit.

18. The system according to claim 17, the system further comprising:
a service managing entity configured to select a service for at least one end-user, to determine at least said first logical service entity and said second logical service entity based on said service, to form a chain comprising said first logical service entity and said second logical service entity based on said service, to determine said at least one trigger condition and said at least one action based on said service and to determine said service determination rule based on said service and user information associated with said at least one end-user.

19. The system according to claim 18, the system further comprising:
a user database configured to provide user data comprising said user information to said first network node.

20. The system according to claim 18, wherein said user information is a condition for comparing at least part of the source address in a packet received at said first network node to a value associated with said at least one end-user.

21. The system according to claim 18, wherein said logical service entities have unique identifiers.

22. The system according to claim 18, the system further comprising:
a service managing entity configured to assign said chain a unique chain identifier and to add said chain identifier into said service determination rule.

23. The system according to claim 14, the system further comprising: a second network node configured to host at least one of said first logical service entity and second logical service entity.

24. The system according to claim 14, wherein said communication network is a mobile communication network.

25. The system according to claim 23, wherein said communication network is a General Packet Radio System (GPRS) Network.

26. The system according to claim 14, wherein said communication network is an IP network and said first network node is an IP router.

27. A network node comprising:
a receiving entity in said first network node configured to receive a first packet;
an assigning entity in said first network node configured to assign a chain comprising at least a first logical service entity and a second logical service entity for said first packet; and
a service chain control entity configured to form a data unit comprising at least part of said first packet, to pass said data unit to said first logical service entity and to pass a second data unit received from said first logical service entity to said second logical service entity.

28. A computer program comprising code adapted to perform the following steps when executed on a data-processing system:
receiving a first packet at said first network node;
assigning in said first network node a chain comprising at least two logical service entities for said first packet based on at least one service determination rule;
forming a data unit comprising at least part of said first packet; and
processing said data unit in at least one logical service entity in said chain.

29. The computer program according to claim 28, wherein said computer program is stored on a computer readable medium.

30. The computer program according to claim 29, wherein said computer readable medium is a magnetic or optical disk.

31. The computer program according to claim 29, wherein said computer readable medium is a read-only memory circuit.
